(19) United States
(12) Patent Application Publication
(10) Pub. No.: US 2010/0123693 A1
(43) Pub. Date: May 20, 2010

(54) DATA LINE DRIVER

(75) Inventor: Takanori Utsunomiya, Oita-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/578,662

(22) Filed: Oct. 14, 2009

(30) Foreign Application Priority Data
Nov. 14, 2008 (JP) 2008-292024

(51) Int. Cl. G09G 5/00

(52) U.S. Cl. 345/205; 345/211

(57) ABSTRACT

A data line driver includes a counter, a data converter, a gray-scale voltage generating circuit, multiple voltage selectors and multiple output circuits. Each voltage selector receives n voltages generated by the gray-scale voltage generating circuit. The voltage selector includes: n switches; a capacitor which holds electric charges; and a selector which generates n control signals to control ON and OFF of the n switches, respectively. The voltage selector selects two voltages out of the n voltages, and makes a control signal variable which is inputted into one of switches to which the two voltages are respectively applied. Thereby, the voltage selector generates k intermediate voltages, and outputs the n voltages and the k intermediate voltages.

### CROSS REFERENCE TO RELATED APPLICATION

This application is based upon and claims the benefit of priority from the prior Japanese Patent Application No. 2008-292024, filed on Nov. 14, 2008, the entire contents of which are incorporated herein by reference.

### FIELD OF THE INVENTION

The invention relates to a data line driver.

### DESCRIPTION OF THE BACKGROUND

In recent years, liquid crystal displays (LCDs) of an active matrix drive type characterized by thinness, light-weight and low power consumption have been widely prevalent. LCDs of this type are widely used as displays of mobile appliances such as portable terminals, PDAs, and laptop PCs. Each of such liquid crystal displays (LCDs) includes a scanning line driver into which scanning line signals are inputted, and a data line driver into which data line signals are inputted. The data line driver drives data lines by use of multi-level gray-scale voltages corresponding to the number of gray scales, and includes a digital-to-analog converter (DAC) as a decoder that coverts video data to the gray-scale voltages. Japanese Patent Application Publication No. 2007-219091 discloses the digital-to-analog converter.

The data line driver driven to display data to be displayed has a problem that, as the number of gray-scale voltages increases in conjunction with enhancement of the image quality (increase in the number of colors), the circuit size of the digital-to-analog converter (DAC), or the chip area of the data line driver increase.

### SUMMARY OF THE INVENTION

According to an aspect of the invention is provided a data line driver comprising a voltage generating circuit configured to receive a first reference voltage and a second reference voltage which is lower than the first reference voltage, the voltage generating circuit dividing a voltage difference between the first reference voltage and the second reference voltage by use of a plurality of ladder resistors and generating n voltages, where n is an integer not smaller than three; and a voltage selector including n switches having first ends to which the mutually different n voltages are respectively applied, the n switches being arranged in parallel to one another, a capacitor provided between second ends of the respective n switches and a lower voltage source, the capacitor being configured to hold electric charges, and a selector configured to generate n control signals to control ON and OFF of the n switches, respectively, wherein the voltage selector is configured to select two voltages from the n voltages and to make a control signal variable, the control signal being inputted into one of switches to which the two voltages are respectively applied, and the voltage selector generates k intermediate voltages, where k is an integer not smaller than one, and the voltage selector outputs the n voltages and the k intermediate voltages.

According to another aspect of the invention is provided a data line driver comprising a voltage generating circuit configured to receive a first reference voltage and a second reference voltage which is lower than the first reference voltage, the voltage generating circuit dividing a voltage difference between the first reference voltage and the second reference voltage by use of a plurality of ladder resistors and generating n voltages, where n is an integer not smaller than three; and a voltage selector including n switches having first ends to which the mutually different n voltages are respectively applied, the n switches being arranged in parallel to one another, a selector configured to generate n control signals to control ON and OFF of the n switches, respectively, a first sample hold circuit including a first capacitor provided on second end sides of the respective n switches, and having a first end connected to the second ends of the respective n switches and a second end connected to a lower voltage source, the first capacitor being configured to hold electric charges, and a first discharging portion having a first end connected to the first end of the first capacitor and a second end connected to the lower voltage source, the first discharging portion being configured to discharge electric charges from the first capacitor, the first sample hold circuit having a first time period for charging the first capacitor with electric charges, and a second time period for outputting a voltage based on the electric charges stored in the first capacitor, and a second sample hold circuit including a second capacitor provided on the second end sides of the respective n switches, and having a first end connected to the second ends of the n switches and a second end connected to the lower voltage source, the second capacitor being configured to hold electric charges, and a second discharging portion having a first end connected to the first end of the second capacitor and a second end connected to the lower voltage source, the second discharging portion being configured to discharge electric charges from the second capacitor, the second sample hold circuit having a third time period for charging the second capacitor with electric charges, and a fourth time period for outputting a voltage based on the electric charges stored in the second capacitor, the third time period overlapping the second time period, the fourth time period overlapping the first time period, wherein the voltage selector is configured to make an ON time period variable, the ON time period being for any one of the first discharging portion and the second discharging portion, and the voltage selector generates k intermediate voltages, where k denotes an integer not smaller than one, and the voltage selector outputs the n voltages and the k intermediate voltages.

According to further another aspect of the invention is provided A data line driver comprising a voltage generating circuit configured to receive a first reference voltage and a second reference voltage which is lower than the first reference voltage, the voltage generating circuit dividing a voltage difference between the first reference voltage and the second reference voltage by use of a plurality of ladder resistors and generating n voltages, where n is an integer not smaller than three; and a voltage selector including n switches having first ends to which the mutually different n voltages are respectively applied, the n switches being arranged in parallel to one another, a capacitor having a first end connected to second ends of the respective n switches and a second end connected to a lower voltage source, the capacitor being configured to hold electric charges, a selector configured to generate n control signals to control ON and OFF of the n switches, respectively, a first precharging portion provided between a higher voltage source and the first end of the capacitor, the first precharging portion being configured to precharge the capacitor to a voltage of the higher voltage source, and a second precharging portion provided between the first end of the capacitor and the lower voltage source, the second precharging portion being configured to precharge the capacitor to a voltage of the lower voltage source, wherein the voltage selector is configured to select one voltage from the n voltages and to make the control signal variable, the control signal being inputted into a switch connected to the selected voltage, and the voltage selector generates k intermediate voltages, where k is an integer not smaller than one, and the voltage selector outputs the n voltages and the k intermediate voltages.

### BRIEF DESCRIPTION OF THE DRAWINGS

FIG. 1 is a schematic block diagram showing a liquid crystal display according to a first embodiment of the invention.

FIG. 2 is a circuit diagram showing a data line driver according to the first embodiment of the invention.

FIG. 3 is a timing chart showing how the data line driver according to the first embodiment of the invention operates.

FIG. 4 is another timing chart showing how the data line driver according to the first embodiment of the invention operates.

FIG. 5 is a diagram showing how the data line driver according to the first embodiment of the invention operates in response to variations in a control signal S2.

FIG. 6 is a timing chart showing how the data line driver according to the first embodiment of the invention operates by use of the control signal S2 having two high-level time periods.

FIG. 7 is a circuit diagram showing a data line driver according to a second embodiment of the invention.

FIG. 8 is a circuit diagram showing a data line driver according to a third embodiment of the invention.

FIG. 9 is a circuit diagram showing a data line driver according to a fourth embodiment of the invention.

FIG. 10 is a timing chart showing how the data line driver according to the fourth embodiment of the invention operates.

FIG. 11 is a circuit diagram showing a data line driver according to a fifth embodiment of the invention.

FIG. 12 is a timing chart showing how the data line driver according to the fifth embodiment of the invention operates.

### DETAILED DESCRIPTION OF THE INVENTION

Embodiments of the invention will be hereinbelow described with reference to the drawings.

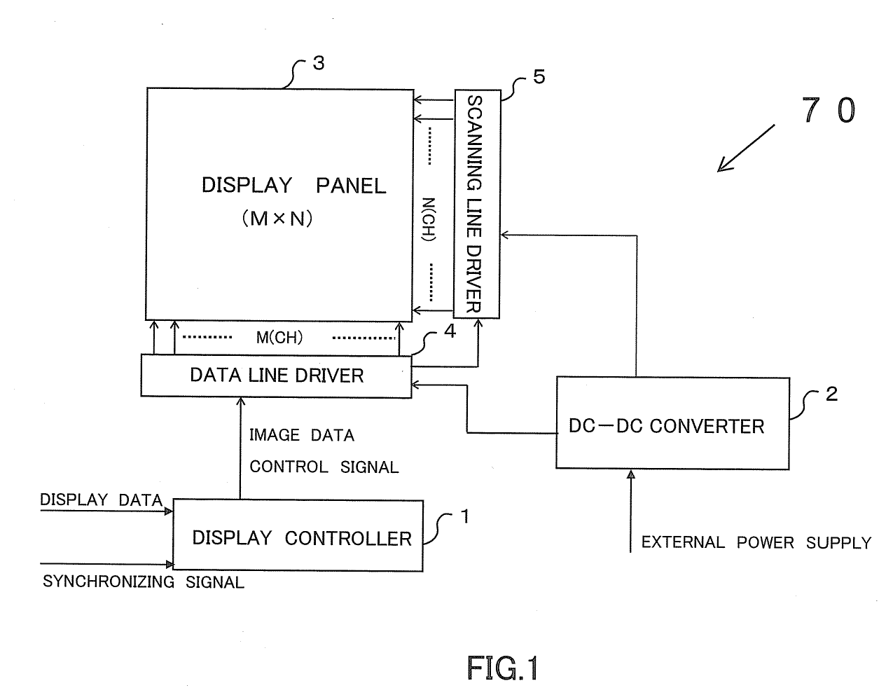

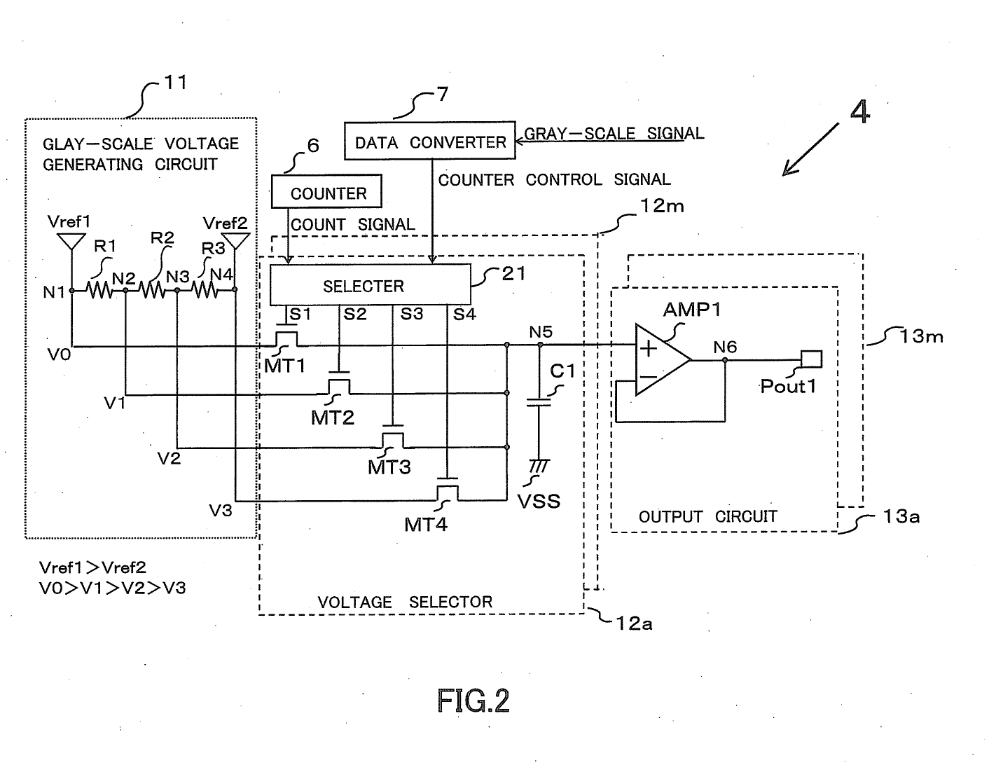

A semiconductor integrated circuit according to a first embodiment of the invention will be described with reference to the drawings. FIG. 1 is a schematic block diagram showing a liquid crystal display. FIG. 2 is a circuit diagram showing a data line driver. A voltage selector increases the number of gray-scale voltages in the embodiment.

As shown in FIG. 1, a liquid crystal display 70 includes a display controller 1, a DC-DC converter 2, a display panel 3, a data line driver 4 and a scanning line driver 5. The liquid crystal display 70 is used for a display of a portable terminal, for example.

The data line driver 4 is termed as an X driver, a source driver or a display driver as well. The scanning line driver 5 is termed as a Y driver or a gate driver as well.

The display controller 1 integrally controls the entire liquid crystal display 70. The display controller 1 receives display data and a synchronizing signal, as well as outputs image data and a control signal to the data line driver 4. In addition, the display controller 1 receives data and a signal which are sent back from the data line driver 4.

The DC-DC converter 2 receives an external power. The DC-DC converter 2 generates a raised power supply voltage, for example, which is needed to operate the data line driver 4 and the scanning line driver 5, supplies the raised power supply voltage to the data line driver 4 and the scanning line driver 5.

The data line driver 4 receives the image data and the control signal which are outputted from the display controller 1, as well as the power which is supplied from the DC-DC converter 2. The data line driver 4 outputs display data, which is needed to drive the display panel 3 for a display operation, to the display panel 3. The data line driver 4 outputs a control signal, which is synchronized with the display data, to the scanning line driver 5.

The scanning line driver 5 receives the control signal outputted from the data line driver 4, and the power supplied from the DC-DC converter 2. The scanning line driver 5 outputs control voltage information, which is needed to drive the display panel 3 for the display operation, to a gate of a thin film transistor (TFT) of the display panel 3.

The display panel 3 includes TFTs, retention capacitors, pixel electrodes (liquid crystal cells) and scanning line loads, which are not illustrated. The display panel 3 receives M channels of display data outputted from the data line driver 4, and N channels of control voltages for the corresponding TFTs which are outputted from the scanning line driver 5. The display panel 3 displays an image which the display panel 3 is driven to display on the basis of the image data.

As shown in FIG. 2, the data line driver 4 includes a counter 6, a data converter 7, a gray-scale voltage generating circuit 11, m voltage selectors (a voltage selector 12a, . . . , a voltage selector 12m) and m output circuits (an output circuit 13a, . . . , an output circuit 13m).

The voltage selector 12a, . . . , the voltage selector 12m have the same circuit configuration. The output circuit 13a, . . . , the output circuit 13m have the same circuit configuration. Each voltage selector is a decoder to convert video data to a gray-scale voltage. Each amplifier circuit is an amplifier to amplify the corresponding gray-scale voltage, and to output the amplified gray-scale voltage. Each voltage selector functions as a digital-to-analog converter (DAC)

The gray-scale voltage generating circuit 11 herein is configured to generate four gray-scale voltages (has three ladder resistors) for a simple explanation of the invention. In the case of a display of a full-color portable terminal device, for example, the number of ladder resistors needs to be increased so that the number of required gray-scales would correspond to the number of ladder resistors.

The gray-scale voltage generating circuit 11 includes resistors R1 to R3. The gray-scale voltage generating circuit 11 receives a reference voltage Vref1 and a reference voltage Vref2, and generates four gray-scale voltages by voltage-division using the resistors R1 to R3. One end of the resistor R1 is connected to a node N1, and the reference voltage Vref1 is inputted to the one end of the resistor R1. The other end of the resistor R1 is connected to a node N2. One end of the resistor R2 is connected to the node N2, and the other end of the resistor R2 is connected to a node N3. One end of the resistor R3 is connected to the node N3, and the other end of the resistor R3 is connected to a node N4. The reference voltage Vref2 is inputted to the other end of the resistor R3.

A relationship between the reference voltage Vref1 and the reference voltage Vref2 is set in such a way as to satisfy

Vref1>Vref2 Equation (1).

The reference voltage Vref1 is set at 4V, for example. The reference voltage Vref2 is set at 1V, for example.

A relationship among a resistance value r1 of the resistor R1, a resistance value r2 of the resistor R2 and a resistance value r3 of the resistor R3 is set in such a way as to satisfy

r1=r2=r3 Equation (2).

As a result, a voltage V0 as a gray-scale voltage at the node N1 is set at 4V. A voltage V1 as a gray-scale voltage at the node N2 is set at 3V. A voltage V2 as a gray-scale voltage at the node N3 is set at 2V. A voltage V3 as a gray-scale voltage at the node N4 is set at 1V.

Here, the four gray-scale voltages are generated by use of the ladder resistors R1 to R3. In a case where n ladder resistors are used, (n+1) gray-scale voltages can be generated.

The data converter 7 receives a gray-scale signal as a video data signal. The data converter 7 converts the gray-scale signal to a counter control signal, and outputs the counter control signal to a selector 21 of a corresponding one of the voltage selectors.

The counter 6 receives a clock signal. The counter 6 has multiple binary counters, for example. The counter 6 drops the frequency of the clock signal, and thus generates a count signal. The counter 6 outputs the count signal to the selector 21 of the voltage selector in an appropriate time period.

Each of the voltage selector 12a, . . . , the voltage selector 12m includes a selector 21, a capacitor C1, and transistors MT1 to MT4. Each of the voltage selector 12a, . . . , the voltage selector 12m further generates intermediate gray-scale voltages which are different from the gray-scale voltages generated by the gray-scale voltage generating circuit 11, and adds the intermediate gray-scale voltages to the gray-scale voltages. Each of the voltage selector 12a, . . . , the voltage selector 12m then outputs the gray-scale voltages and the intermediary gray-scale voltages to the corresponding output circuit. Detailed description will be given later.

The selector 21 is formed of multiple logic circuits, for example. The selector 21 receives the counter control signal outputted from the data converter 7, and the count signal outputted from the counter 6. The selector 21 performs a logical operation on the basis of the counter control signal and the count signal. The selector 21 generates control signals S1 to S4. The control signal S1 is a signal to control the ON and OFF of the transistor MT1 functioning as a switch. The control signal S2 is a signal to control the ON and OFF of the transistor MT2 functioning as a switch. The control signal S3 is a signal to control the ON and OFF of the transistor MT3 functioning as a switch. The control signal S4 is a signal to control the ON and OFF of the transistor MT4 functioning as a switch.

The transistor MT1 is provided between the node N1 and a node N5. The control signal S1 outputted from the selector 21 is inputted to the gate of the transistor MT1. The transistor MT1 performs ON and OFF operations on the basis of the control signal S1. The transistor MT2 is provided between the node N2 and the node N5. The control signal S2 outputted from the selector 21 is inputted to the gate of the transistor MT2. The transistor MT2 performs ON and OFF operations on the basis of the control signal S2. The transistor MT3 is provided between the node N3 and the node N5. The control signal S3 outputted from the selector 21 is inputted to the gate of the transistor MT3. The transistor MT3 performs ON and OFF operations on the basis of the control signal S3. The transistor MT4 is provided between the node N4 and the node N5. The control signal S4 outputted from the selector 21 is inputted to the gate of the transistor MT4. The transistor MT4 performs ON and OFF operations on the basis of the control signal S4.

Here, the transistors MT1 to MT4 are N-channel insulated-gate field-effect transistors. Hereinbelow, all the transistors in use illustrated in the drawings are insulated-gate field-effect transistors. Each insulated-gate field-effect transistor is a MOSFET or a MISFET.

The capacitor C1 is provided between the node N5 and a lower voltage source VSS whose electric potential is a ground potential, and functions as a retention capacitor. The capacitor C1 should preferably be such a capacitor that a film quality of a dielectric film constituting the capacitor is excellent, and that a leakage from the capacitor is very small in amount. In addition, the capacitor C1 should preferably be such a capacitor that the charging of the capacitor with electric charges and the discharging of electric charges from the capacitor (the charge time, the discharge time, the charge transient characteristic, the discharge transient characteristic and the like) can recur.

Each of the output circuit 13a, . . . , the output circuit 13m includes an amplifier AMP1 and an output terminal Pout1.

The amplifier AMP1 is provided between the node N5 and a node N6. An input-side plus port of the amplifier AMP1 is connected to the node N5. As a feedback signal, a signal from the output side of the amplifier AMP1 is inputted to an input-side minus port of the amplifier AMP1. The amplifier AMP1 amplifies a gray-scale voltage at the node N5, and outputs the resultant gray-scale voltage, as a display data signal needed to operate the display panel 3 for the display operation, to the display panel 3 (illustrated in FIG. 1) via the output terminal Pout1.

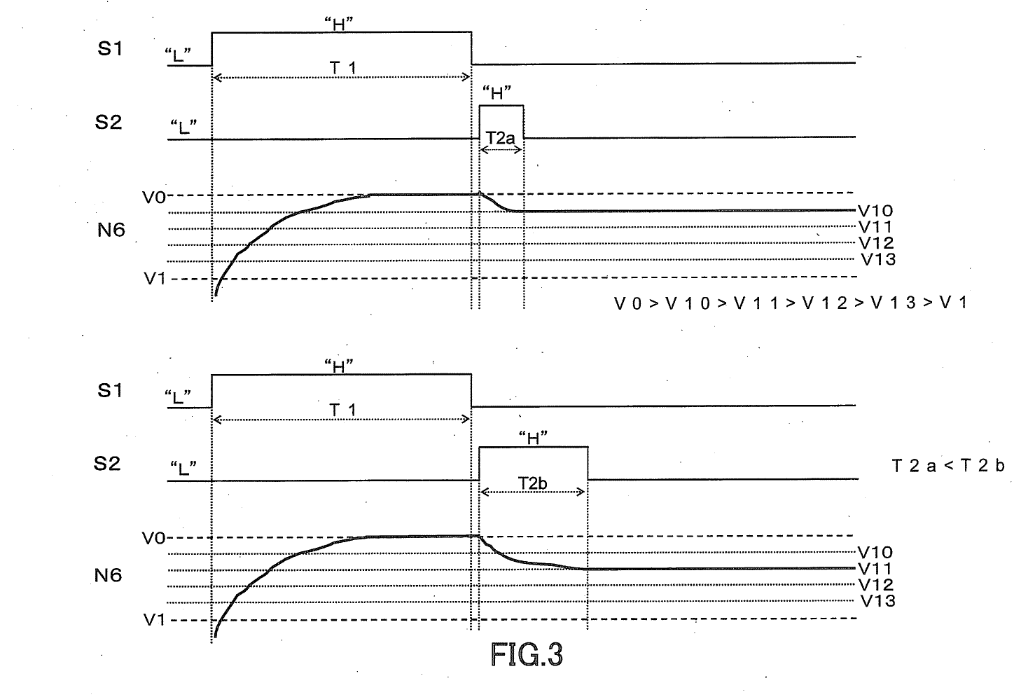

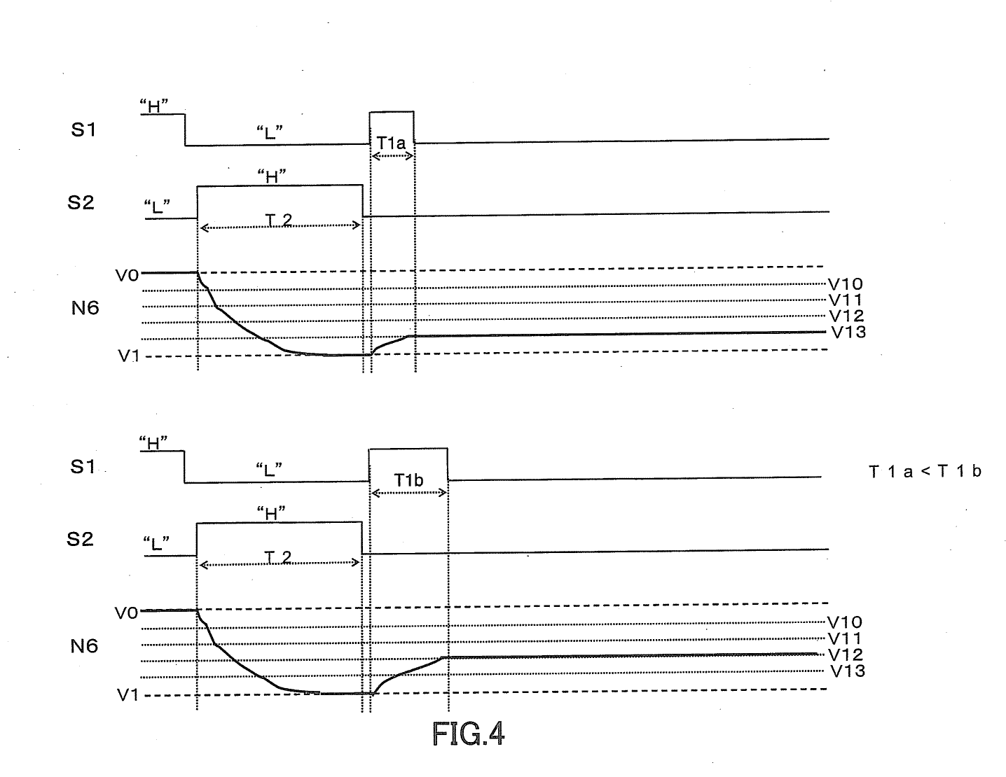

Next, descriptions will be provided for how the data line driver operates with reference to FIGS. 3 to 6. FIGS. 3 and 4 are timing charts each showing how the data line driver 4 operates. Here, on the basis of the control signal S1 and the control signal S2 outputted from the selector 21, the data line driver 4 generates four intermediate voltages V10 to V13 within a range between the gray-scale voltage V0 and the gray-scale voltage V1, which are generated by the gray-scale voltage generating circuit 11. In FIG. 3, a high-level time period for which the control signal S2 is at a high level is made variable. In FIG. 4, a high-level time period for which the control signal S1 is at a high level is made variable.

As shown in FIG. 3, by use of the high-level control signal S1 for a high-level time period T1, the transistor MT1 is tuned on for the high-level time period T1, thereby connecting the node N1 to the node N5. Accordingly, a voltage of the node N5 is set equal to the voltage V0 (4V), and the capacitor C1 is charged. As a result, a voltage of the node N6 is set equal to the voltage V0 (4V) (a voltage level of the display data signal is set at 4V)

A relationship between a time Tc1 (not illustrated) for which the capacitor C1 is charged by applying 4V to the capacitor C1 and the high-level time period T1 is set in such a way as to satisfy

T1>>Tc1 Equation (3).

The capacitor C1 is fully charged with electric charges by applying 4V to the capacitor C1.

Subsequently, the control signal S1 changes from the high level to a low level. By use of the high-level control signal S2 for a relatively-short high-level time period T2a, the transistor MT2 is tuned on for the high-level period T2a, thereby connecting the node N2 to the node N5. Accordingly, the voltage of the node N5 is set equal to the voltage V1 (3V), and part of the electric charges which are stored in the capacitor C1 is discharged from the capacitor C1. As a result, the voltage of the node N6 is set equal to the voltage V10 which is lower than the voltage V0 (the voltage level of the display data signal is set at V10).

Subsequently, by use of the high-level control signal S1 for the high-level time period T1, the transistor MT1 is turned on, thereby connecting the node N1 to the node N5. Accordingly, the voltage of the node N5 is set equal to the voltage V0 (4V), and the capacitor C1 is charged. Thereafter, by use of the high-level control signal S2 for a high-level time period T2b longer than the high-level time period Ta, the transistor MT2 is turned on for the high-level time period T2b, thereby connecting the node N2 to the node N5. Accordingly, the voltage of the node N5 is set equal to the voltage V1 (3V), and part of the electric charges which are stored in the capacitor C1 is discharged from the capacitor C1. As a result, the voltage of the node N6 is set equal to the voltage V11 which is lower than the voltage V10 (the voltage level of the display data signal is set at V11).

A relationship among a time Tc2 (not illustrated) for which electric charges are discharged from the capacitor C1 by applying 3V to the capacitor C1, the high-level time period T2a, and the high-level time period T2b are set in such a way as to satisfy

T2a<T2<<Tc2 Equation (4).

When the high-level time period T2a and the high-level time period T2b are respectively set at appropriate values, and when an amount of electric charges to be discharged from the capacitor C1 is thus controlled, the voltages V10 and V11 can be respectively set at 3.8V and 3.6V, for example.

As shown in FIG. 4, by use of the high-level control signal S1, the transistor MT1 is turned on. Subsequently, by use of the low-level control signal S1, the transistor MT1 is turned off. Thereafter, by use of high-level the control signal S2 for a high-level time period T2, the transistor MT2 is turned on for the high-level time period T2, thereby connecting the node N2 to the node N5. Accordingly, the voltage of the node N5 is set equal to the voltage V1 (3V), and the electric charges are discharged from the capacitor C1 by applying 3V to the capacitor C1. As a result, the voltage of the node N6 is set equal to the voltage V1 (the voltage level of the display data signal is set at 3V).

A relationship among a time Tc21 (not illustrated) for which electric charges are discharged from the capacitor C1 by applying 3V to the capacitor C1 and the high-level time period T2 is set in such a way as to satisfy

T2>>Tc21 Equation (5).

Electric charges are discharged from the capacitor C1, and the capacitor C1 accordingly stores only an amount of electric charges which are stored when 3V is applied to the capacitor C1.

Subsequently, once the control signal S2 is changed from the high level to the low level, the transistor MT1 is turned on for a high-level time period T1a by use of the high-level control signal S1 for the high-level time period T1a, thereby connecting the node N1 to the node N5. Accordingly, the voltage of the node N5 is set equal to the voltage V0 (4V), and the capacitor C1 is charged. As a result, the voltage of the node N6 is set equal to the voltage V13 which is higher than the voltage V1 (the voltage level of the display data signal is set at V13).

Subsequently, by use of the high-level control signal S1, the transistor MT1 is turned on. Thereafter, by use of the low-level control signal S1, the transistor MT1 is turned off. Afterward, by use of the high-level control signal S2 for the high-level time period T2, the transistor MT2 is turned on for the high-level time period T2, thereby connecting the node N2 and the node N5. Accordingly, the voltage of the node N5 is set equal to the voltage V1 (3V), and part of the electric charges is discharged from the capacitor C1 in order that the electric charges stored in the capacitor C1 should correspond to the 3V. Afterward, by use of the high-level control signal S1 for a high-level time period T1b longer than the high-level time period T1a, the transistor MT1 is turned on for the high-level time period T1b, thereby connecting the node N1 and the node N5. Accordingly, the voltage of the node N5 is set equal to the voltage V0 (4V), and the capacitor C1 is charged. As a result, the voltage of the node N6 is set equal to a voltage V12 which is higher than the voltage V13 (the voltage level of the display data signal is set at V12).

A relationship among a time Tc12 for which the capacitor C1 is charged by applying 4V to capacitor C1, the high-level time period T1a and the high-level time period T1b is set in such a way as to satisfy

T1a<T1b<Tc12 Equation (6).

When the high-level time period T1a and the high-level time period T1b are respectively set at appropriate values, and when an amount of electric charges with which to charge the capacitor C1 is thus controlled, the voltages V12 and V13 can be respectively set at 3.4V and 3.2V, for example.

Note that four intermediate gray-scale voltages are similarly generated between the voltage V1 and the voltage V2, as well as between the voltage V2 and the voltage V3 (the illustrations and descriptions will be omitted).

As a result, each voltage selector generates the gray-scale voltages (the 12 intermediate gray-scale voltages) which are different from the four gray-scale voltages generated by the gray-scale voltage generating circuit 11, and adds the 12 intermediate gray-scale voltages to the four gray-scale voltages. Thereby, a display data signal representing the 16 gray scales is outputted from the output circuit to the display panel 3. For this reason, even if the number of gray-scale voltages is increased, it is possible to suppress the enlargement of the circuit size of each of the gray-scale voltage generating circuit, the voltage selectors and the like. Accordingly, it is possible to suppress the increase in the chip area of the data line driver. In a case of 6 bits (64 gray scales), for example, the data line driver according to the embodiment can make the number of transistors smaller by 60% than a conventional data line driver in which each voltage selector generates no intermediate gray-scale voltages. Nevertheless, the circuit sizes of the control circuits including the counter circuit 6 and the like are slightly enlarged.

Here, the high-level time period for the control signal S2 is made variable, so that the voltages V10 and V11 are generated, whereas the high-level time period for the control signal S1 is made variable, so that the voltages V12 and V13 are generated. Nevertheless, the four voltages V10 to V13 may be generated by use of any other method.

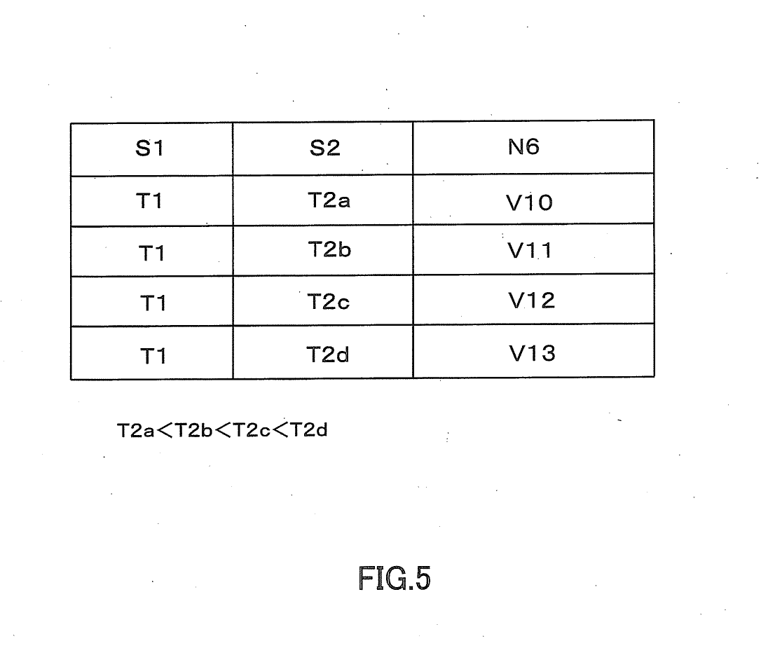

FIG. 5 is a diagram showing how the data line driver operates in response to variations in the control signal S2.

As shown in FIG. 5, a relationship among the high-level time period T2a, the high-level time period T2b, a high-level time period T2c and a high-level time period T2d of the control signal S2 and the time Tc2 for which electric charges are discharged from the capacitor C1 by applying 3V to the capacitor C1, for example, is set in such a way as to satisfy

T2a<T2b<T2c<T2d<<Tc2 Equation (7).

Thereby, it is possible to generate the intermediate gray-scale voltages V10 to V13.

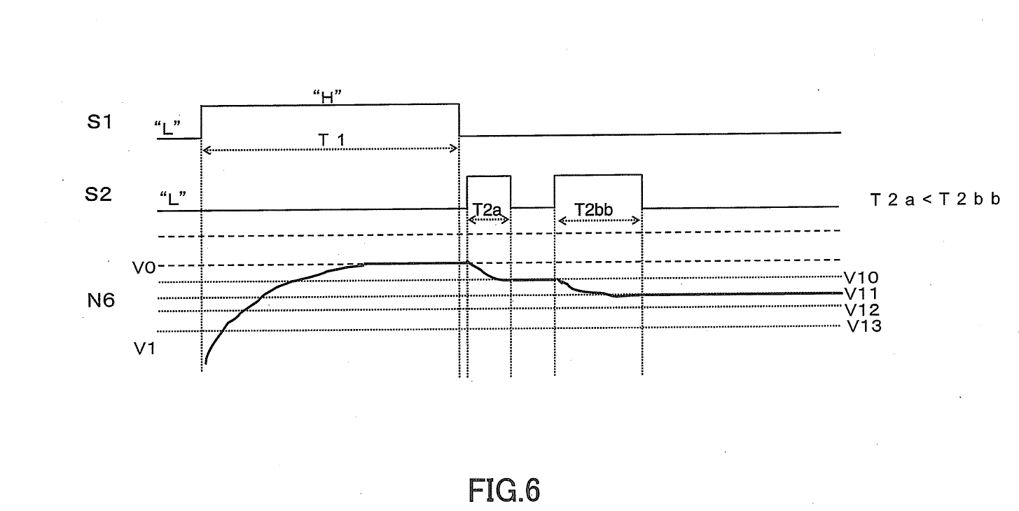

FIG. 6 is a timing chart showing how the data line driver operates by use of the control signal S2 which has two high-level time periods. As shown in FIG. 6, by use of the high-level control signal S1 for the high-level time period T1, the transistor MT1 for the high-level time period T1 is turned on, thereby connecting the node N1 to the node N5. Accordingly, the voltage of the node N5 is set equal to the voltage V0 (4V), and the capacitor C1 is charged. Once the control signal S1 is changed from the high level to the low level, the intermediate gray-scale voltage V11 can be generated by use of the control signal S2 having the high-level time period T2a and a high-level time period T2bb which is longer than the high-level time period T2a, for example. By arbitrarily using the control signal S2 having two high-level time periods, the intermediate gray-scale voltages V10, V12 and V13 can be generated similarly.

In the case of the semiconductor integrated circuit according to the embodiment, as described above, the liquid crystal display 70 includes the display controller 1, the DC-DC converter 2, the display panel 3, the data line driver 4, and the scanning line driver 5. The data line driver 4 includes the counter 6, the data converter 7, the gray-scale voltage generating circuit 11, the m voltage selectors, and the m output circuits. The gray-scale voltage generating circuit 11 includes the resistors R1 to R3, and receives the reference voltage Vref1 and the reference voltage Vref2. Thus, the gray-scale voltage generating circuit 11 generates the four gray-scale voltages V0 to V3 by voltage-division using the resistors R1 to R3. Each voltage selector includes the selector 21, the capacitor C1, and the transistors MT1 to MT4. The selector 21 generates the control signals S1 to S4 to control the respective transistors MT1 to MT4, on the basis of the counter control signal and the count signal. Each voltage selector selects two adjacent signals from the control signals S1 to S4, and makes the high-level time period for one of the two signals variable. Thereby, the voltage selector generates the intermediate gray-scale voltages which are different from the gray-scale voltages V0 to V3. Thus, each voltage selector outputs the 16 gray-scale voltages in total, which include the gray-scale voltages V0 to V3 and the 12 intermediate gray-scale voltages, to the corresponding output circuit.

This configuration makes it possible to suppress the enlargement of the circuit sizes of the voltage selectors as the DACs, even if the number of gray-scale voltages increases as the image quality is enhanced. In addition, this configuration makes it possible to suppress the enlargement of the circuit size of the gray-scale voltage generating circuit 11. Accordingly, it is possible to reduce the chip area of the data line driver 4, and to thereby reduce the space occupied by the liquid crystal display 70 and the costs.

Although the embodiment causes each voltage selector to generate the four intermediate gray-scale voltages on the basis of the two adjacent voltages selected out of the voltages outputted from the gray-scale voltage generating circuit 11, the invention is not limited to this embodiment. Instead of the four intermediate gray-scale voltages, k intermediate gray-scale voltages (note that k denotes any number of 1, 2, 3 and 5 as well as an integer larger than 5) may be generated. Furthermore, the intermediate gray-scale voltages may be generated by use of two voltages which are not adjacent to each other, instead of the two adjacent voltages.

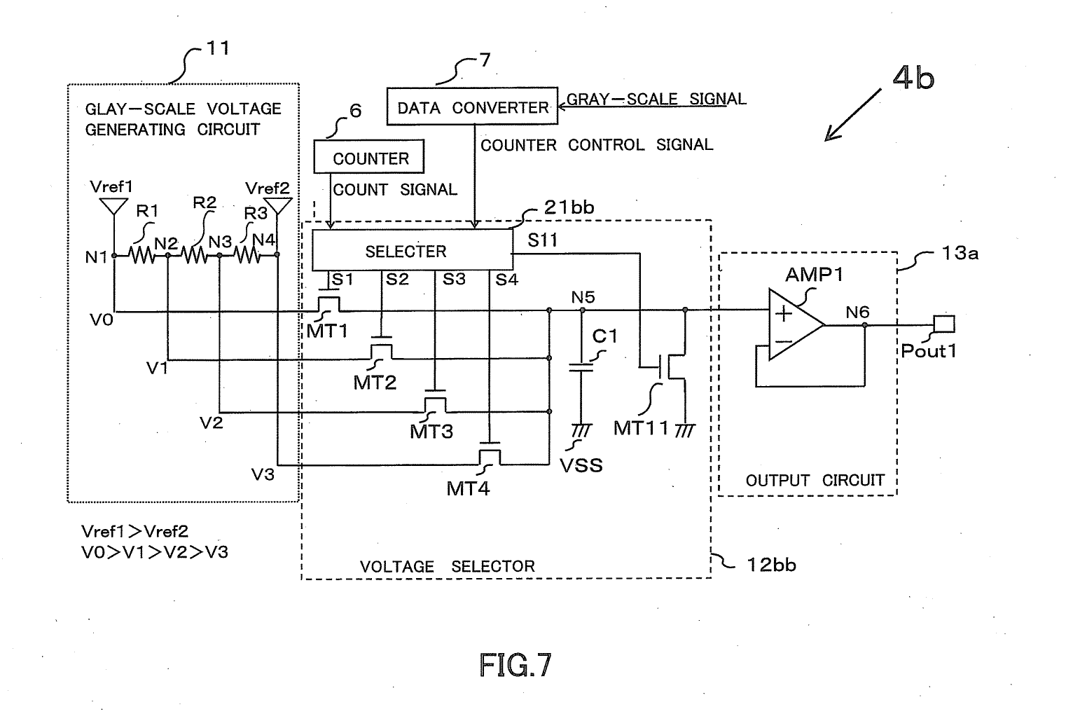

A semiconductor integrated circuit according to a second embodiment of the invention will be described with reference to the drawings. FIG. 7 is a circuit diagram showing a data line driver. In the embodiment, the configuration of each voltage selector is changed.

Hereinbelow, the same portions as those of the first embodiment will be denoted by the same reference numerals. Descriptions for such portions will be omitted. Descriptions will be provided only for portions which are different from those of the first embodiment.

As shown in FIG. 7, a data line driver 4b includes the counter 6, the data converter 7, the gray-scale voltage generating circuit 11, voltage selectors 12bb and the output circuits 13a. Note that m voltage selectors and m output circuits are provided, although not illustrated. Each voltage selector 12bb functions as a digital-to-analog converter (DAC)

Each voltage selector 12bb includes a selector 21bb, the capacitor C1, the transistors MT1 to MT4, and a transistor MT11. Each voltage selector 12bb generates intermediate gray-scale voltages which are different from the gray-scale voltages generated by the gray-scale voltage generating circuit 11, and adds the intermediate gray-scale voltages to the gray-scale voltages. Each voltage selector 12bb then outputs the gray-scale voltages and the intermediary gray-scale voltages to the corresponding output circuit.

The selector 21bb is formed of multiple logic circuits, for example. The selector 21bb receives the counter control signal outputted from the data converter 7, and the count signal outputted from the counter 6. The selector 21bb performs a logical operation on the basis of the counter control signal and the count signal. The selector 21bb generates the control signals S1 to S4, and a control signal S11. The control signal S1 is a signal to control the ON and OFF of the transistor MT1 functioning as a switch. The control signal S2 is a signal to control the ON and OFF of the transistor MT2 functioning as a switch. The control signal S3 is a signal to control the ON and OFF of the transistor MT3 functioning as a switch. The control signal S4 is a signal to control the ON and OFF of the transistor MT4 functioning as a switch. The control signal S11 is a signal to control the ON and OFF of the transistor MT11 functioning as a switch.

The transistor MT11 is an N-channel insulated-gate field-effect transistor. The drain of the transistor MT11 is connected to the node N5, and the source of the. transistor MT11 is connected to the lower voltage source VSS. The control signal S11 outputted from the selector 21bb is inputted into the gate of the transistor MT11. The transistor MT11 carries out ON and OFF operations on the basis of the control signal S11. The transistor MT11 functions as discharging means for discharging electric charges which are stored in the capacitor C1.

By making the high-level time period for the control signal S11 variable, the transistor MT11 variably decreases the electric charges stored in the capacitor C1 by an amount corresponding to the high-level time period. As a result, it is possible to apply a voltage correction to the intermediate gray-scale voltages which are generated by use of the transistor MT1 to MT4 and the capacitor C1. In addition, it is possible to increase the number of gray-scale voltages in comparison with that of the first embodiment.

In the embodiment, any two control signals are selected from the control signals S1 to S4, and the voltage correction is applied to the intermediate gray-scale voltages by making the high-level time period for the transistor MT11 variable. Instead, any one control signal maybe selected from the control signals S1 to S4 so that the intermediate gray-scale voltages are generated by making the high-level time period for the transistor MT11 variable.

In the case of the semiconductor integrated circuit according to the embodiment, as described above, the data line driver 4b includes the counter 6, the data converter 7, the gray-scale voltage generating circuit 11, the voltage selectors 12bb and the output circuits 13a. The gray-scale voltage generating circuit 11 includes the resistors R1 to R3, and receives the reference voltage Vref1 and the reference voltage Vref2. Thus, the gray-scale voltage generating circuit 11 generates the four gray-scale voltages V0 to V3 by voltage-division using the resistors R1 to R3. Each voltage selector 12bb includes the selector 21bb, the capacitor C1, the transistors MT1 to MT4, and the transistor MT11. The selector 21bb generates the control signals S1 to S4 and S11 to control the respective transistors MT1 to MT4 and the transistor MT11, on the basis of the counter control signal and the count signal. Each voltage selector 12bb makes the high-level time period for any one of the control signals S1 to S4 variable to generate the intermediate gray-scale voltages which are different from the gray-scale voltages V0 to V3. In addition, the voltage selector 12bb applies the correction to the intermediate gray-scale voltages by use of the transistor MT11. Thus, each voltage selector 12bb outputs the gray-scale voltages V0 to V3 and the intermediate gray-scale voltages to the corresponding output circuit.

For this reason, the embodiment can bring about the same effect as the first embodiment does, and additionally makes it possible to set finer intermediate gray-scale voltages. Accordingly, it is possible to achieve a reduction in the chip area of the data line driver 4b, as well as reductions in the space occupied by the liquid crystal display and the costs.

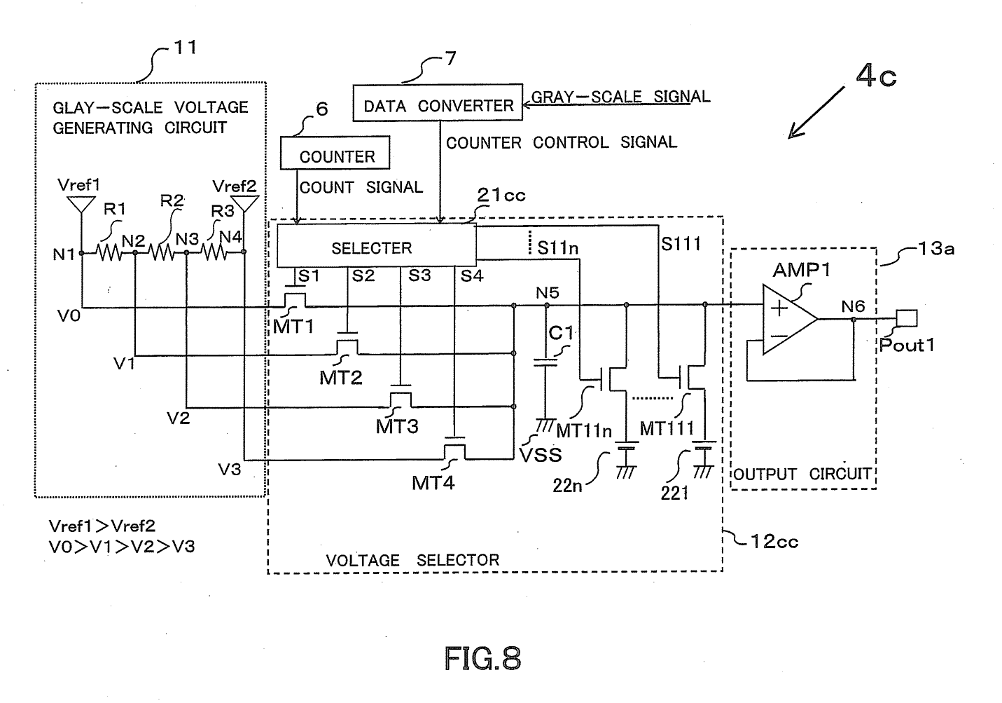

A semiconductor integrated circuit according to a third embodiment of the invention will be described with reference to the drawings. FIG. 8 is a circuit diagram showing a data line driver. In the embodiment, multiple power supplies are provided in a lower voltage source-side of the output side of each voltage selector.

Hereinbelow, the same portions as those of the first embodiment will be denoted by the same reference numerals. Descriptions for such portions will be omitted. Descriptions will be provided only for portions which are different from those of the first embodiment.

As shown in FIG. 8, a data line driver 4c includes the counter 6, the data converter 7, the gray-scale voltage generating circuit 11, voltage selectors 12cc and the output circuits 13a. As in the case of the first embodiment, m voltage selectors and m output circuits are provided, although not illustrated. Each voltage selector 12cc functions as a digital-to-analog converter (DAC).

Each voltage selector 12cc includes a selector 21cc, the capacitor C1, the transistors MT1 to MT4, transistors MT111 to transistors MT11n, and power supplies 221 to 22n. Each voltage selector 12cc generates intermediate gray-scale voltages which are different from the gray-scale voltages generated by the gray-scale voltage generating circuit 11, and adds the intermediate gray-scale voltages to the gray-scale voltages. Each voltage selector 12cc outputs the gray-scale voltages and the intermediary gray voltages to the corresponding output circuit.

The selector 21cc is formed of multiple logic circuits, for example. The selector 21cc receives the counter control signal outputted from the data converter 7, and the count signal outputted from the counter 6. The selector 21cc performs a logical operation on the basis of the counter control signal and the count signal. The selector 21cc generates the control signals S1 to S4, and control signals S111 to S11n. The control signal S1 is a signal to control the ON and OFF of the transistor MT1 functioning as a switch. The control signal S2 is a signal to control the ON and OFF of the transistor MT2 functioning as a switch. The control signal S3 is a signal to control the ON and OFF of the transistor MT3 functioning as a switch. The control signal S4 is a signal to control the ON and OFF of the transistor MT4 functioning as a switch. The control signal S111 is a signal to control the ON and OFF of the transistor MT111. The control signal S11n is a signal to control the ON and OFF of the transistor MT11n.

Each of the transistors MT111 to MT11n is an N-channel insulated-gate field-effect transistor. Note that illustrations and descriptions of the transistors MT112 to MT11(n−1) and the control signals S112 to S11(n−1) are omitted.

The drain of the transistor MT111 is connected to the node N5. The control signal S111 outputted from the selector 21cc is inputted into the gate of the transistor MT111. A higher potential side of the power supply 221 is connected to the source of the transistor MT111, whereas a lower potential side of the power supply 221 is connected to the lower voltage source VSS. The drain of the transistor MT11n is connected to the node N5. The control signal S11n outputted from the selector 21cc is inputted into the gate of the transistor MT11n. A higher potential side of the power supply 22n is connected to the source of the transistor MT11n, whereas a lower potential side of the power supply 22n is connected to the lower voltage source VSS.

By making the high-level time period for the control signal S111 variable, the transistor MT111 sets the node N5-side of the capacitor C1 equal to a voltage of the power supply 221 during the high-level time period. On the basis of this setup, the transistor MT111 variably decreases or variably increases the electric charges stored in the capacitor C1 by an amount corresponding to the high-level time period. By making the high-level time period for the control signal S11n variable, the transistor MT11n sets the node N5-side of the capacitor C1 equal to a voltage of the power supply 22n during the high-level time period. On the basis of this setup, the transistor MT11n variably decreases or variably increases electric charges stored in the capacitor C1 by an amount corresponding to the high-level time period.

As a result, it is possible to apply voltage correction to the intermediate gray-scale voltages which are generated by use of the transistors MT1 to MT4 and the capacitor C1. In addition, it is possible to increase the number of gray-scale voltages in comparison with that of the first embodiment.

In the embodiment, any two control signals are selected from the control signals S1 to S4, and the voltage correction is applied to the intermediate gray-scale voltages by making the high-level time period for anyone of the transistors MT111 to MT11n variable. Instead, any one control signal may be selected from the control signals S1 to S4 so that the intermediate gray-scale voltages are generated by making the high-level time period for any one of the transistors MT111 to MT11n variable.

In the case of the semiconductor integrated circuit according to the embodiment, as described above, the data line driver 4c includes the counter 6, the data converter 7, the gray-scale voltage generating circuit 11, the voltage selectors 12cc and the output circuits 13a. The gray-scale voltage generating circuit 11 includes the resistors R1 to R3, and receives the reference voltage Vref1 and the reference voltage Vref2. Thus, the gray-scale voltage generating circuit 11 generates the four gray-scale voltages V0 to V3 by voltage-division using the resistors R1 to R3. Each voltage selector 12cc includes the selector 21cc, the capacitor C1, the transistors MT1 to MT4, the transistors MT111 to MT11n, and the power supplies 221 to 22n. The selector 21cc generates the control signals S1 to S4 and S111 to S11n to control the respective transistors MT1 to MT4, and MT111 to MT11n, on the basis of the counter control signal and the count signal. Each voltage selector 12cc makes the high-level time period for any one of the control signals S1 to S4 variable. Thereby, the voltage selector 12cc generates the intermediate gray-scale voltages which are different from the gray-scale voltages V0 to V3. In addition, the voltage selector 12cc turns on anyone of the transistors MT111 to MT11n, and thus applies the correction to the intermediate gray-scale voltages by use of any one of the transistors NT111 to MT11n. Each voltage selector 12cc outputs the gray-scale voltages V0 to V3 and the intermediary gray-scale voltages to the corresponding output circuit.

For this reason, the embodiment can bring about the same effect as the first embodiment does, and additionally makes it possible to set finer intermediate gray-scale voltages. Accordingly, the embodiment makes it possible to achieve a reduction in the chip area of the data line driver 4c, as well as reductions in the space occupied by the liquid crystal display and the costs.

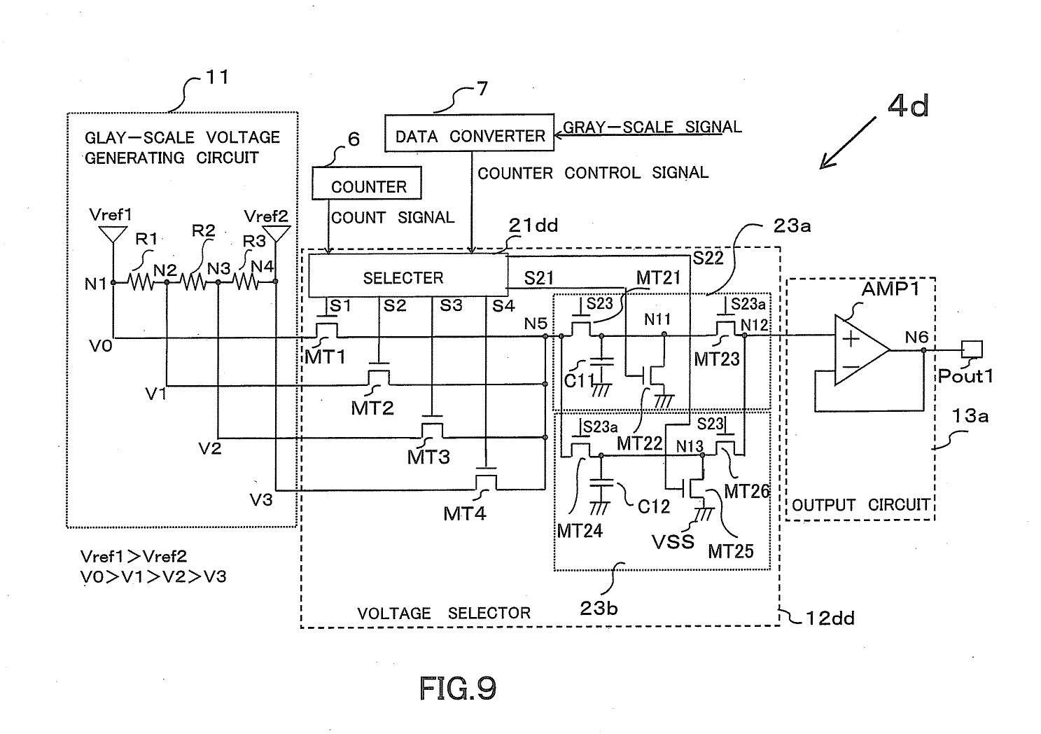

A semiconductor integrated circuit according to a fourth embodiment of the invention will be described with reference to the drawings. FIG. 9 is a circuit diagram showing a data line driver. In the embodiment, sample hold circuits are provided which are provided on the output side of each voltage selector.

Hereinbelow, the same portions as those of the first embodiment will be denoted by the same reference numerals. Descriptions for such portions will be omitted. Descriptions will be provided only for portions which are different from those of the first embodiment.

As shown in FIG. 9, a data line driver 4d includes the counter 6, the data converter 7, the gray-scale voltage generating circuit 11, voltage selectors 12dd and the output circuits 13a. As in the case of the first embodiment, m voltage selectors and m output circuits are provided, although not illustrated. Each voltage selector 12dd functions as a digital-to-analog converter (DAC).

Each voltage selector 12dd includes a selector 21dd, a sample hold circuit 23a, a sample hold circuit 23b, and the transistors MT1 to MT4. Each voltage selector 12dd generates intermediate gray-scale voltages which are different from the gray-scale voltages generated by the gray-scale voltage generating circuit 11, and adds the intermediate gray-scale voltages to the gray-scale voltages. Each voltage selector 12dd outputs the gray-scale voltages and the intermediary gray-scale voltages to the corresponding output circuit.

The selector 21dd is formed of multiple logic circuits, for example. The selector 21dd receives the counter control signal outputted from the data converter 7, and the count signal outputted from the counter 6. The selector 21dd performs a logical operation on the basis of the counter control signal and the count signal. The selector 21dd generates the control signals S1 to S4, a control signal S21 and a control signal S22. The control signal S1 is a signal to control the ON and OFF of the transistor MT1 functioning as a switch. The control signal S2 is a signal to control the ON and OFF of the transistor MT2 functioning as a switch. The control signal S3 is a signal to control the ON and OFF of the transistor MT3 functioning as a switch. The control signal S4 is a signal to control the ON and OFF of the transistor MT4 functioning as a switch. The control signal S21 is a signal to control the ON and OFF of the transistor MT22 of the sample hold circuit 23a. The control signal S22 is a signal to control the ON and OFF of a transistor MT25 of the sample hold circuit 23b.

The sample hold circuit 23a includes transistors MT21 to MT23 and a capacitor C11. The sample hold circuit 23b includes transistors MT24 to MT26 and a capacitor C12. Each of the sample hold circuits 23a and 23b plays a role of preventing voltage variations from being propagated to the output circuit while precharging the capacitors C11 and C12, and while discharging electric charges from the capacitors C11 and C12, respectively. The sample hold circuits 23a and 23b are configured in a way that one of the sample hold circuits 23a and 23b charges the corresponding capacitor with electric charges while the other outputs a voltage based on electric charges stored in the corresponding capacitor. The transistors MT21 to MT26 are N-channel insulated-gate field-effect transistors.

The drain of the transistor MT21 is connected to the node N5, and the source of the transistor MT21 is connected to anode N11. A control signal S23 is inputted into the gate of the transistor MT21. The transistor MT21 performs ON and OFF operations on the basis of the control signal S23. One end of the capacitor C11 is connected to the node N11, and the other end of the capacitor C11 is connected to the lower voltage source VSS. The capacitor C11 functions as a retention capacitor. The drain of the transistor MT22 is connected to the node N11, and the source of the transistor MT22 is connected to the lower voltage source VSS. The control signal S21 outputted from the selector 21dd is inputted into the gate of the transistor MT22. The transistor MT22 performs ON and OFF operations on the basis of the control signal S21. The transistor MT22 functions as discharging means for discharging electric charges which are stored in the capacitor 11. The drain of the transistor MT23 is connected to the node N11. The source of the transistor MT23 is connected to a node N12 located closer to the corresponding output circuit. A control signal S23a which is an inversion signal of the control signal S23 is inputted to the gate of the transistor MT23. The transistor MT23 performs ON and OFF operations on the basis of the control signal S23a.

Here, LCD output drive signals (LOAD) used outside the data line driver 4d are respectively used as the control signals S23 and S23a, but may be generated inside the data line driver 4d, instead.

The drain of the transistor MT24 is connected to the node. N5, and the source of the transistor MT24 is connected to a node N13. The control signal S23a is inputted into the gate of the transistor MT24. The transistor MT24 performs ON and OFF operations on the basis of the control signal S23a. One end of the capacitor C12 is connected to the node N13, and the other end of the capacitor C12 is connected to the lower voltage source VSS. The capacitor C12 functions as a retention capacitor. The drain of the transistor MT25 is connected to the node N13, and the source of the transistor MT25 is connected to the lower voltage source VSS. The control signal S22 outputted from the selector 21dd is inputted into the gate of the transistor MT25. The transistor MT25 performs ON and OFF operations on the basis of the control signal S22. The transistor MT25 functions as discharging means for discharging electric charges which are stored in the capacitor 12. The drain of the transistor MT26 is connected to the node N13. The source of the transistor MT26 is connected to the node N12 located closer to the corresponding output circuit. The gate of the control signal 23 is inputted to the transistor MT26. The transistor MT26 performs ON and OFF operations on the basis of the control signal S23.

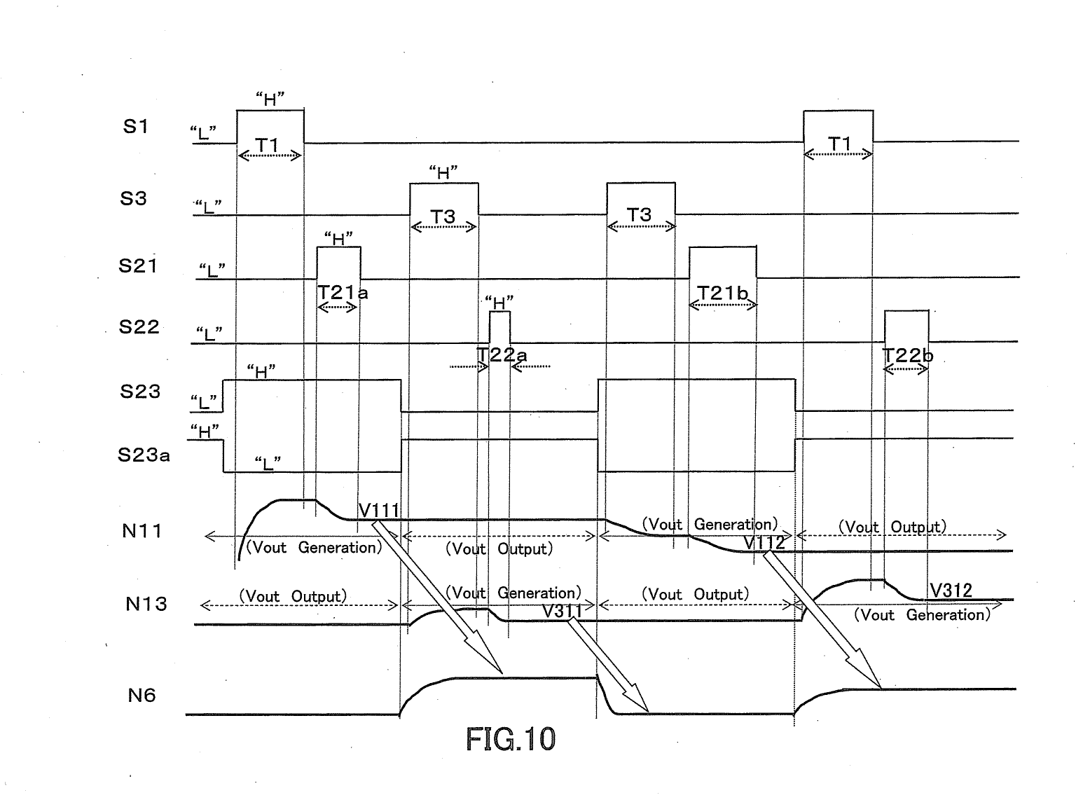

Next, how the data line driver operates will be described with reference to FIG. 10. FIG. 10 is a timing chart showing how the data line driver operates.

As shown in FIG. 10, by use of the high-level control signal S1 for the high-level time period T1, the transistor MT1 is turned on only for the high-level time period T1. The transistor MT21 of the sample hold circuit 23a is kept on during the high-level time period T1, because the control signal S23 is at a high level. Consequently, electric charges are stored in the capacitor C11 (the capacitor C11 is precharged with electric charges). A voltage of the node N11 is raised to the voltage V0.

Subsequently, the control signal S1 is changed from the high level to a low level. The control signal S21 is changed from a low level to a high level. During a high-level time period T21a, the transistor MT22 is turned on and part of the electric charges stored in the capacitor C11 is thus discharged. For this reason, a voltage of the node N11 is set at a voltage V111 which is lower than the voltage V0. This means that the voltage V111 is generated in the sample hold circuit 23a (as indicated by Vout Generation).

On the other hand, in the sample hold circuit 23b, the transistors MT24 and MT25 are turned off and the transistor MT26 is turned on. Thus, a voltage corresponding to electric charges stored in the capacitor C12 is outputted to the output circuit (as indicated by Vout Output).

Thereafter, the control signal S23 is changed from the high level to a low level. In parallel, the control signal S23a is changed from a low level to a high level. In the sample hold circuit 23a, the transistors MT21 and MT22 are turned off and the transistor MT23 is turned on. Thus, the voltage V111 corresponding to the electric charges stored in the capacitor C11 is outputted to the output circuit (as indicated by Vout Output).

Afterward, the control signal S3 is changed from a low level to a high level. During a high-level time period T3 for the control signal S3, the transistor MT3 is turned on. The transistor MT24 is kept on, and the transistors MT25 and MT26 are kept off. For this reason, electric charges are stored in the capacitor C12 (the capacitor C12 is precharged with electric charges), and a voltage of the node N13 is set equal to the voltage V3.

After that, the control signal S3 is changed from the high level to the low level. The control signal S22 is changed from a high level to a low level. During a high-level time period T22a, the transistor MT25 is turned on and part of the electric charges stored in the capacitor C12 is thus discharged. Thus, a voltage of the node N13 is set at a voltage V311 which is lower than the voltage V3. This means that the voltage V311 is generated in the sample hold circuit 23b (as indicated by Vout Generation).

Subsequently, the control signal S23 is changed from the low level to the high level. In parallel, the control signal S23a is changed from the high level to the low level. In the sample hold circuit 23b, the transistors MT24 and MT25 are turned off, and the transistor MT26 is turned on. Thus, the voltage V311 corresponding to the electric charges stored in the capacitor C12 is outputted to the output circuit (as indicated by Vout Output).

Afterward, the control signal S3 is changed from the low level to the high level. By use of the high-level control signal S3 for the high-level time period T3, the transistor MT3 is turned on during the high-level time period T3. Because the control signal S23 is at the high level during this high-level time period T3, the transistor MT21 of the sample hold circuit 23a is kept on. Accordingly, part of the electric charges stored in the capacitor C11 is discharged, and the voltage of the node N11 is dropped to the voltage V3.

After that, the control signal S3 is changed from the high level to the low level. The control signal S21 is changed from the low level to the high level. By use of the high-level control signal S21 for a high-level time period T21b, the transistor MT22 is turned on during the high-level time period T21b. For this reason, part of the electric charges stored in the capacitor C11 is discharged, and the voltage of the node N11 is thus dropped to a voltage V112. This means that the voltage V112 is generated in the sample hold circuit 23a (as indicated by Vout Generation).

Subsequently, the control signal S23 is changed from the high level to the low level. In parallel, the control signal S23a is changed from the low level to the high level. In the sample hold circuit 23a, the transistors MT21 and MT22 are turned off and the transistor MT23 is turned on. For this reason, the voltage V112 corresponding to the electric charges stored in the capacitor C11 is outputted to the output circuit (as indicated by Vout Output).

Thereafter, the control signal S1 is changed from the low level to the high level. By use of the high-level control signal S21 for the high-level time period T1, the transistor MT1 is turned on during the high-level time period T1. During the high-level time period T1, the control signal S23a is at the high level and thus the transistor MT24 of the sample hold circuit 23b is kept on. Accordingly, the capacitor C12 is charged with electric charges, and the voltage of the node N13 is raised to the voltage V0.

Afterward, the control signal S1 is changed from the high level to the low level. The control signal S22 is changed from the low level to the high level. By use of the high-level control signal S22 for a high-level time period T22b, the transistor MT25 is turned on during the high-level time period T22b. Thus, part of the electric charges stored in the capacitor C12 is discharged, and the voltage of the node N13 is dropped to a voltage V312 which is lower than the voltage V0. This means that the voltage V312 is generated in the sample hold circuit 23b (as indicated by Vout Generation).

The Vout generation time period is alternately set between the sample hold circuits 23a and 23b and the Vout output time period alternately between the sample hold circuits 23a and 23b, and the high-level time periods for the control signals S21 and S22 are made variable. This makes it possible for the voltage selector 12dd to generate the intermediate gray-scale voltages which are different from the gray-scale voltages generated by the gray-scale voltage generating circuit 11.

In the semiconductor integrated circuit according to the embodiment, as described above, the data line driver 4d includes the counter 6, the data converter 7, the gray-scale voltage generating circuit 11, the voltage selectors 12dd and the output circuits 13a. The gray-scale voltage generating circuit 11 includes the resistors R1 to R3, and receives the reference voltage Vref1 and the reference voltage Vref2. Thus, the gray-scale voltage generating circuit 11 generates the four gray-scale voltages V0 to V3 by voltage-division using the resistors R1 to R3. Each voltage selector 12dd includes the selector 21dd, the transistors MT1 to MT4, the sample hold circuit 23a, and the sample hold circuit 23b. On the basis of the counter control signal and the count signal, the selector 21dd generates the control signals S1 to S4 to control the respective transistors MT1 to MT4, the control signal S21 to control the transistor MT22 of the sample hold circuit 23a, and the control signal S22 to control the transistor MT25 of the sample hold circuit 23b. The sample hold circuits 23a and 23b play a role of preventing voltage variations from being propagated to the output circuit while precharging the capacitors C11 and C12 with electric charges, and while discharging electric charges from the capacitors C11 and C12, respectively. The voltage selector 12dd makes the high-level time period for the control signal S21 or S22 variable, and thus generates the intermediate gray-scale voltages which are different from the gray-scale voltages V0 to V3.

For this reason, the embodiment can bring about the same effect as the first embodiment does, and additionally makes it possible to suppress fluctuation of the gray-scale voltages which are outputted from each voltage selector 12dd. Accordingly, the embodiment makes it possible to achieve a reduction in the chip area of the data line driver 4d, as well as reductions in the space occupied by the liquid crystal display and the costs.

In the embodiment, the high-level time period for the control signal S1 is set as the high-level time period T1 for which the capacitor C11 or the capacitor C12 is fully charged with electric charges, and the high-level time period for the control signal S3 is set as the high-level time period T3 for which the capacitor C11 or the capacitor C12 is fully charged with electric charges. However, note that the invention is not necessarily limited to the embodiment. A high-level time period for which the capacitor C11 or the capacitor C12 is not fully charged with electric charges may be set depending on the necessity.

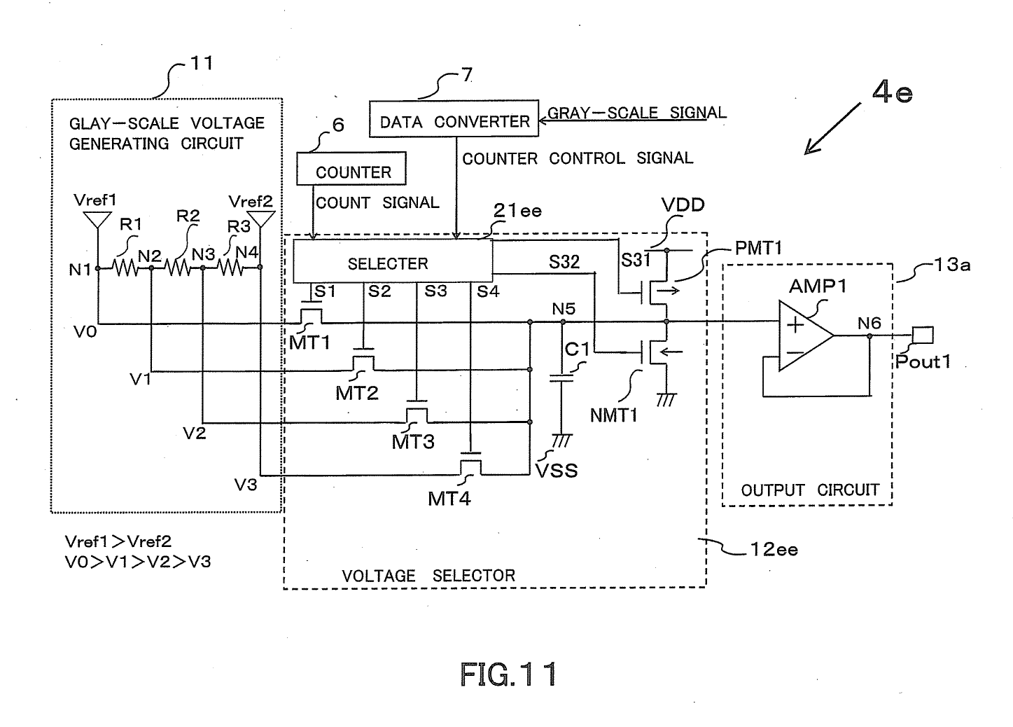

A semiconductor integrated circuit according to a fifth embodiment of the invention will be described with reference to the drawings. FIG. 11 is a circuit diagram showing a data line driver. In the embodiment, a P-channel MOS transistor is provided on the higher voltage source side of the output side of each voltage selector, whereas an N-channel MOS transistor is provided on the lower voltage source side of the output side of each voltage selector.

Hereinbelow, the same portions as those of the first embodiment will be denoted by the same reference numerals. Descriptions for such portions will be omitted. Descriptions will be provided only for portions which are different from those of the first embodiment.

As shown in FIG. 11, a data line driver 4e includes the counter 6, the data converter 7, the gray-scale voltage generating circuit 11, voltage selectors 12ee and the output circuits 13a. As in the case of the first embodiment, m data line driver 4e and m output circuits are provided, although not illustrated. Each voltage selector 12ee functions as a digital-to-analog converter (DAC).

Each voltage selector 12ee includes a selector 21ee, the capacitor C1, the transistors MT1 to MT4, a P-channel MOS transistor PMT1 and an N-channel MOS transistor NMT1. Each voltage selector 12ee generates intermediate gray-scale voltages which are different from the gray-scale voltages generated by the gray-scale voltage generating circuit 11, and adds the intermediate gray-scale voltages to the gray-scale voltages. Each voltage selector 12ee outputs the gray-scale voltages and the intermediary gray-scale voltages to the corresponding output circuit. The voltage selector 12ee is precharged to the higher voltage source voltage in advance when the gray-scale voltages outputted from the voltage selector 12ee are intended to be set at a voltage higher than a half of the higher voltage source voltage. The voltage selector 12ee is precharged to the lower voltage source voltage in advance when the gray-scale voltages outputted from the voltage selector 12ee are intended to be set at a voltage lower than a half of the higher voltage source voltage. This setup scheme makes it possible to reduce the charging current and the discharging current in amount, and accordingly to reduce the consumed current of the data line driver 4e as compared with those of the first to fourth embodiments.

The selector 21ee is formed of multiple logic circuits, for example. The selector 21ee receives the counter control signal outputted from the data converter 7, and the count signal outputted from the counter 6. The selector 21ee performs a logical operation on the basis of the counter control signal and the count signal. The selector 21ee generates the control signals S1 to S4, a control signal S31 and a control signal S32. The control signal S1 is a signal to control the ON and OFF of the transistor MT1 functioning as a switch. The control signal S2 is a signal to control the ON and OFF of the transistor MT2 functioning as a switch. The control signal S3 is a signal to control the ON and OFF of the transistor MT3 functioning as a switch. The control signal S4 is a signal to control the ON and OFF of the transistor MT4 functioning as a switch. The control signal S31 is a signal to control the ON and OFF of the P-channel MOS transistor PMT1. The control signal S32 is a signal to control the ON and OFF of the N-channel MOS transistor NMT1.

Here, the P-channel MOS transistor PMT1 and the N-channel MOS transistor NMT1 are used. Instead, however, a P-channel MIS transistor and an N-channel MIS transistor may be used.

The source of the P-channel MOS transistor PMT1 is connected to a higher voltage source VDD, and the drain of the P-channel MOS transistor PMT1 is connected to the node N5. The control signal S31 outputted from the selector 21ee is inputted into the gate of the P-channel MOS transistor PMT1. The P-channel MOS transistor PMT1 performs ON and OFF operations on the basis of the control signal S31. The P-channel MOS transistor PMT1 sets the node N5 equal to a voltage of the higher voltage source VDD when the turned on.

The drain of the N-channel MOS transistor NMT1 is connected to the node N5 and the drain of the P-channel MOS transistor PMT1, and the source of the N-channel MOS transistor NMT1 is connected to the lower voltage source VSS. The control signal S32 outputted from the selector 21ee is inputted into the gate of the N-channel MOS transistor NMT1. The N-channel MOS transistor NMT1 performs ON and OFF operations on the basis of the control signal S32. The N-channel MOS transistor NMT1 sets the node N5 equal to a voltage of the lower voltage source VSS when turned on.

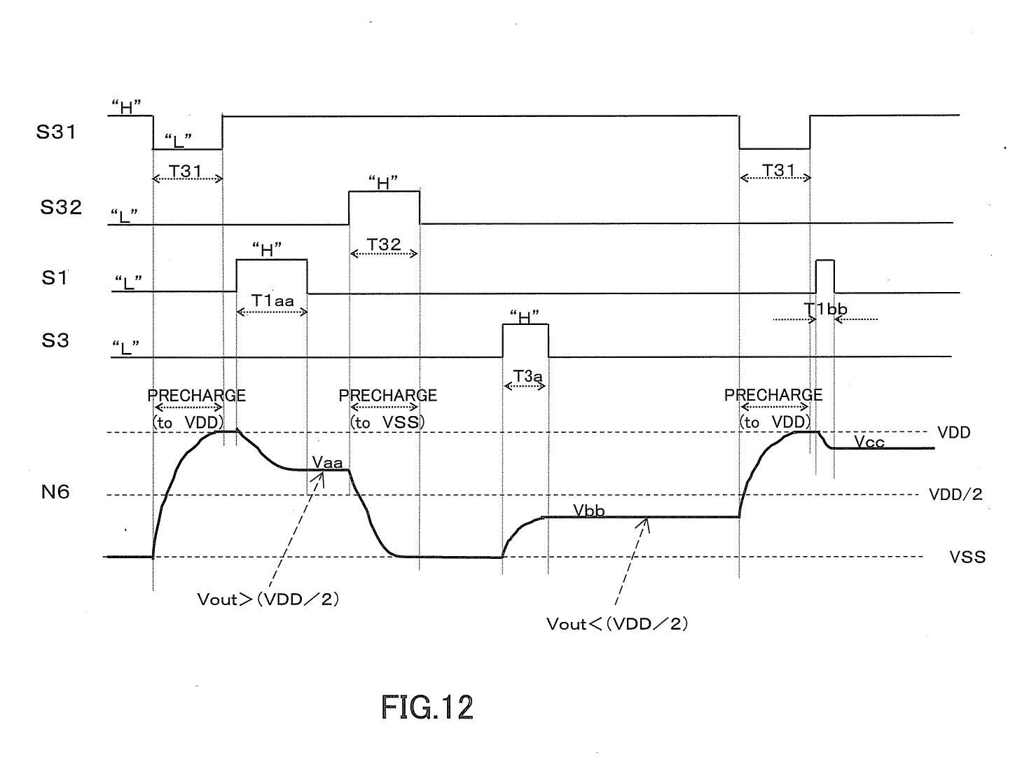

Next, how the data line driver operates will be described with reference to FIG. 12. FIG. 12 is a timing chart showing how the data line driver operates.

As shown in FIG. 12, when the gray-scale voltages outputted from each voltage selector 12ee are intended to be set higher than a half of the higher voltage source voltage (denoted by VDD/2), the control signal S31 outputted from the selector 21ee is changed from a high level to a low level. By use of the low-level controls signal S31 for a low-level time period T31, the P-channel MOS transistor PMT1 is turned on during the low-level time period T31. The capacitor C1 is precharged with electric charges, and a voltage of the node N5 is raised. The node N6 of the output circuit 13a is precharged to the voltage of the higher voltage source VDD. Note that the voltage of the higher voltage source VDD is set higher than the voltage V0.

Subsequently, the control signal S31 is changed from the low level to the high level, and the control signal S1 is changed from a low level to a high-level. By use of the high-level control signal S1 for a high-level time period T1aa, the transistor MT1 is turned on during the high-level time period T1aa. Part of electric charges stored in the capacitor C1 is discharged, and a voltage of the node N5 is dropped. Accordingly, a voltage of the node N6 of the output circuit 13a is set equal to a voltage Vaa which is lower than the voltage of the higher voltage source VDD and the voltage V0.

Thereafter, the control signal S1 is changed from the high level to the low level. The control signal S32 is changed from a low level to a high level. By use of the high-level control signal S32 for a high-level time period T32, the N-channel MOS transistor NMT1 is turned on during the high-level time period T32. The electric charges stored in the capacitor C1 are discharged, and the voltage of the node N5 is dropped. Accordingly, the voltage of the node N6 of the output circuit 13a is set equal to the voltage of the lower voltage source VSS (the node N6 is precharged to the voltage of the lower voltage source VSS).

When the gray-scale voltages outputted from each voltage selector 12ee are intended to be set lower than a half of the higher voltage source voltage (denoted by VDD/2), the control signal S3 is changed from a low level to a high level. By use of the high-level control signal S3 for a high-level time period T3a shorter than the high-level time period T3, the transistor MT3 is turned on during the high-level time period T3a. The capacitor C1 is charged with electric charges, and the voltage of the node N5 is raised. The voltage of the node N6 of the output circuit 13a is set at a voltage Vbbwhich is lower than the voltage V3.

Next, when the gray-scale voltages outputted from the voltage selector 12ee are set higher than a half of the higher voltage source voltage (denoted by VDD/2), the control signal S31 is changed from the high level to the low level. By use of the low-level control signal S31 for a low-level time period T31, the P-channel MOS transistor PMT1 is turned on during the low-level time period T31. Thus, the capacitor C1 is precharged with electric charges, and the voltage of the node N5 is raised. Accordingly, the node N6 of the output circuit 13a is precharged to the voltage of the higher voltage source VDD.

Afterward, the control signal S31 is changed from the low level to the high level. The control signal S1 is changed from the low level to the high level. By use of the high-level control signal S1 for a high-level time period T1bb shorter than the high-level time period T1aa, the transistor MT1 is turned on during the high-level time period T1bb. Part of the electric charges stored in the capacitor C1 is discharged, and the voltage of the node N5 is dropped. Accordingly, the node N6 of the output circuit 13a is set at the voltage Vbb that is higher than the voltage Vaa and lower than the voltage of the higher voltage source VDD and the voltage V0.

The P-channel MOS transistor PMT1 or the N-channel MOS transistor NMT1 is turned on as appropriate. Any one of the control signals S1 to S4 is selected. By making the high-level time period for the selected signal variable, it is possible for the voltage selector 12ee to generate the intermediate gray-scale voltages which are different from the gray-scale voltages generated by the gray-scale voltage generating circuit 11.

In the semiconductor integrated circuit according to the embodiment, as described above, the data line driver 4e includes the counter 6, the data converter 7, the gray-scale voltage generating circuit 11, the voltage selectors 12ee and the output circuits 13a. The gray-scale voltage generating circuit 11 includes the resistors R1 to R3, and receives the reference voltage Vref1 and the reference voltage Vref2. Thus, the gray-scale voltage generating circuit 11 generates the four gray-scale voltages V0 to V3 by voltage-division using the resistors R1 to R3. Each voltage selector 12ee includes the selector 21ee, the capacitor C1, the transistors MT1 to MT4, the P-channel MOS transistor PMT1 and the N-channel MOS transistor NMT1. On the basis of the counter control signal and the count signal, the selector 21ee generates the control signals S1 to S4 to control the respective transistors MT1 to MT4, the control signal S31 to control the P-channel MOS transistor PMT1, and the control signal S32 to control the N-channel transistor NMT1. The P-channel MOS transistor PMT1 functions as precharging means for precharging the capacitor C1 to the voltage VDD. The N-channel MOS transistor NMT1 functions as precharging means for precharging the capacitor C1 to the voltage VSS. The voltage selector 12ee makes the high-level time period for any one of the control signals S1 to S4 variable, and thus generates the intermediate gray-scale voltages which are different from the gray-scale voltages V0 to V3.

For this reason, the embodiment can bring about the same effect as the first embodiment does, and additionally makes it possible to cut down a mean consumed current as compared with that of the first embodiment because it is possible to reduce the voltage fluctuation to a level lower than “VDD/2.” Accordingly, the embodiment makes it possible to achieve a reduction in the chip area of the data line driver 4e, as well as reductions in the space occupied by the liquid crystal display and the costs.

The invention is not limited to the foregoing embodiments. The invention may be variously modified as long as the modification does not depart from the scope of the invention.

In the embodiments, the invention is applied to a data line driver of a liquid crystal display. Instead, however, the invention can be applied to a driver of a flat panel display (FPD) such as an organic light emitting diode (OLED) and a plasma display panel (PDP), for example. In addition, the invention can be applied to an electron volume, instead of a driver. Moreover, in the embodiments, the N-channel insulated-gate field-effect transistor is used as each of the transistors MT1 to MT4 provided in each voltage selector. Instead, however, a P-channel insulated-gate field-effect transistor, a transfer gate including an N-channel insulated-gate field-effect transistor and a P-channel insulated-gate field-effect transistor which are connected to each other in parallel, and the like may be used.

What is claimed is:

1. A data line driver comprising:
a voltage generating circuit configured to receive a first reference voltage and a second reference voltage which is lower than the first reference voltage, the voltage generating circuit dividing a voltage difference between the first reference voltage and the second reference voltage by use of a plurality of ladder resistors and generating n voltages, where n is an integer not smaller than three; and
a voltage selector including
n switches having first ends to which the mutually different n voltages are respectively applied, the n switches being arranged in parallel to one another,
a capacitor provided between second ends of the respective n switches and a lower voltage source, the capacitor being configured to hold electric charges, and
a selector configured to generate n control signals to control ON and OFF of the n switches, respectively,
wherein the voltage selector is configured to select two voltages from the n voltages and to make a control signal variable, the control signal being inputted into one of switches to which the two voltages are respectively applied, and the voltage selector generates k intermediate voltages, where k is an integer not smaller than one, and the voltage selector outputs the n voltages and the k intermediate voltages.

2. The data line driver according to claim 1, wherein
the voltage selector is configured to select two adjacent voltages from the n voltages and to make a time period variable, the time period being a time period for which a control signal inputted into one of switches connected respectively to the two voltages turns on the one switch, and the voltage selector generates a plurality of different intermediate voltages.

3. The data line driver according to claim 1, further comprising:
a counter including a plurality of binary counters, the counter being configured to output a count signal to the selector on a basis of a clock signal inputted into the counter; and
a data converter configured to receive a data signal, convert the data signal to a counter control signal, and to output the counter control signal to the selector.

4. The data line driver according to claim 1, wherein each of the switches is any one of an N-channel insulated-gate field-effect transistor, a P-channel insulated-gate field-effect transistor and a transfer gate.

5. The data line driver according to claim 1, further comprising an N-channel insulated-gate field-effect transistor having a drain connected to one end of the capacitor, a source connected to the lower voltage source, and a gate receiving a control signal outputted from the selector, the transistor being configured to discharge electric charges, which are stored in the capacitor, while the transistor is ON.

6. The data line driver according to claim 1, further comprising a P-channel insulated-gate field-effect transistor having a source connected to one end of the capacitor, a drain connected to the lower voltage source, and a gate receiving a control signal outputted from the selector, the transistor being configured to discharge electric charges, which are stored in the capacitor, while the transistor is ON.

7. The data line driver according to claim 1, further comprising:
a power supply having a lower potential side connected to the lower voltage source; and
an N-channel insulated-gate field-effect transistor having a drain connected to one end of the capacitor, a source connected to a higher potential side of the power supply, and a gate receiving a control signal outputted from the selector, the transistor being configured to charge the capacitor with electric charges, or to discharge electric charges, which are stored in the capacitor, while the transistor is ON.

8. The data line driver according to claim 1, further comprising:
a power supply having a lower potential side connected to the lower voltage source; and
an P-channel insulated-gate field-effect transistor having a source connected to one end of the capacitor, a drain connected to a higher potential side of the power supply, and a gate receiving a control signal outputted from the selector, the transistor being configured to charge the capacitor with electric charges, or to discharge electric charges, which are stored in the capacitor, while the transistor is ON.

9. A data line driver comprising:
a voltage generating circuit configured to receive a first reference voltage and a second reference voltage which is lower than the first reference voltage, the voltage generating circuit dividing a voltage difference between the first reference voltage and the second reference voltage by use of a plurality of ladder resistors and generating n voltages, where n is an integer not smaller than three; and
a voltage selector including
n switches having first ends to which the mutually different n voltages are respectively applied, the n switches being arranged in parallel to one another,
a selector configured to generate n control signals to control ON and OFF of the n switches, respectively,
a first sample hold circuit including
a first capacitor provided on second end sides of the respective n switches, and having a first end connected to the second ends of the respective n switches and a second end connected to a lower voltage source, the first capacitor being configured to hold electric charges, and
a first discharging portion having a first end connected to the first end of the first capacitor and a second end connected to the lower voltage source, the first discharging portion being configured to discharge electric charges from the first capacitor,
the first sample hold circuit having a first time period for charging the first capacitor with electric charges, and a second time period for outputting a voltage based on the electric charges stored in the first capacitor, and
a second sample hold circuit including
a second capacitor provided on the second end sides of the respective n switches, and having a first end connected to the second ends of the n switches and a second end connected to the lower voltage source, the second capacitor being configured to hold electric charges, and
a second discharging portion having a first end connected to the first end of the second capacitor and a second end connected to the lower voltage source, the second discharging portion being configured to discharge electric charges from the second capacitor,
the second sample hold circuit having a third time period for charging the second capacitor with electric charges, and a fourth time period for outputting a voltage based on the electric charges stored in the second capacitor, the third time period overlapping the second time period, the fourth time period overlapping the first time period,
wherein the voltage selector is configured to make an ON time period variable, the ON time period being for any one of the first discharging portion and the second discharging portion, and the voltage selector generates k intermediate voltages, where k denotes an integer not smaller than one, and the voltage selector outputs the n voltages and the k intermediate voltages.

10. The data line driver according to claim 9, further comprising:
a counter including a plurality of binary counters, the counter configured to output a count signal to the selector on a basis of a clock signal inputted into the counter; and
a data converter configured to receive a data signal, convert the data signal to a counter control signal, and output the counter control signal to the selector.

11. The data line driver according to claim 9, wherein each of the switches is any one of an N-channel insulated-gate field-effect transistor, a P-channel insulated-gate field-effect transistor and a transfer gate.

12. The data line driver according to claim 9, wherein each of the first and second discharging portions is formed of any one of an N-channel insulated-gate field-effect transistor, a P-channel insulated-gate field-effect transistor and a transfer gate.

13. A data line driver comprising:
a voltage generating circuit configured to receive a first reference voltage and a second reference voltage which is lower than the first reference voltage, the voltage generating circuit dividing a voltage difference between the first reference voltage and the second reference voltage by use of a plurality of ladder resistors and generating n voltages, where n is an integer not smaller than three; and
a voltage selector including
n switches having first ends to which the mutually different n voltages are respectively applied, the n switches being arranged in parallel to one another,
a capacitor having a first end connected to second ends of the respective n switches and a second end connected to a lower voltage source, the capacitor being configured to hold electric charges,
a selector configured to generate n control signals to control ON and OFF of the n switches, respectively,
a first precharging portion provided between a higher voltage source and the first end of the capacitor, the first precharging portion being configured to precharge the capacitor to a voltage of the higher voltage source, and
a second precharging portion provided between the first end of the capacitor and the lower voltage source, the second precharging portion being configured to precharge the capacitor to a voltage of the lower voltage source,
wherein the voltage selector is configured to select one voltage from the n voltages and to make the control signal variable, the control signal being inputted into a switch connected to the selected voltage, and the voltage selector generates k intermediate voltages, where k is an integer not smaller than one, and the voltage selector outputs the n voltages and the k intermediate voltages.

14. The data line driver according to claim 13, further comprising:
a counter including a plurality of binary counters, the counter being configured to output a count signal to the selector on a basis of a clock signal inputted into the counter; and
a data converter configured to receive a data signal, convert the data signal to a counter control signal, and output the counter control signal to the selector.

15. The data line driver according to claim 13, wherein each of the switches is any one of an N-channel insulated-gate field-effect transistor, a P-channel insulated-gate field-effect transistor and a transfer gate.

16. The data line driver according to claim 13, wherein
the first precharging portion is a P-channel insulated-gate field-effect transistor, and
the second precharging portion is an N-channel insulated-gate field-effect transistor.
